(19) United States
(12) Patent Application Publication
(10) Pub. No.: US 2012/0201223 A1
(43) Pub. Date: Aug. 9, 2012

(54) Method and Apparatus for Avoiding Physical Random Access Channel Collisions

(75) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/384,170

(22) PCT Filed: May 7, 2010
(86) PCT No.: PCT/US2010/034028

§ 371 Date: Jan. 13, 2012

Related U.S. Application Data
(60) Provisional application No. 61/249,340, filed on Oct. 7, 2009.

(51) Int. Cl. H04W 74/08; H04W 36/00

(52) U.S. Cl. 370/331; 370/328

(57) ABSTRACT

A method and apparatus for avoiding Physical Random Access Channel collisions is provided. The method may comprise transmitting, by a first user equipment (UE), a first access request using a synchronization code in a subframe to a Node B, and receiving an acknowledgement from the Node B, wherein the acknowledgement indicates that a second UE has transmitted a second access request in the subframe using the synchronization code. Further, the method may comprise receiving, in a sub-frame, a first synchronization code from a first UE and a second synchronization code from a second UE, and preventing transmission of an acknowledgment to both the first and second UEs based on a determination that the received first and second synchronization codes are the same.

### CROSS-REFERENCE TO RELATED APPLICATION(S)

This application claims the benefit of U.S. Provisional Patent Application No. 61/249,340 entitled “APPARATUS AND METHOD FOR AVOIDING PHYSICAL RANDOM ACCESS CHANNEL COLLISIONS,” filed on Oct. 7, 2009, which is expressly incorporated by reference herein in its entirety.

### BACKGROUND

1. Field

Aspects of the present disclosure relate generally to wireless communication systems, and more particularly, to avoid Physical Random Access Channel collisions.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method includes transmitting, by a first user equipment (UE), a first access request using a synchronization code in a subframe to a Node B, and receiving an acknowledgement from the Node B, wherein the acknowledgement indicates that a second UE has transmitted a second access request in the subframe using the synchronization code.

In an aspect of the disclosure, an apparatus includes means for transmitting, by a first UE, a first access request using a synchronization code in a subframe to a Node B, and means for receiving an acknowledgement from the Node B, wherein the acknowledgement indicates that a second UE has transmitted a second access request in the subframe using the synchronization code.

In an aspect of the disclosure, a computer program product includes a computer-readable medium which includes code for transmitting, by a first UE, a first access request using a synchronization code in a subframe to a Node B, and code for receiving an acknowledgement from the Node B, wherein the acknowledgement indicates that a second UE has transmitted a second access request in the subframe using the synchronization code.

In an aspect of the disclosure, an apparatus includes at least one processor, and a memory coupled to the at least one processor. In such an aspect, the at least one processor may be configured to transmit, by a first UE, a first access request using a synchronization code in a subframe to a Node B, and receive an acknowledgement from the Node B, wherein the acknowledgement indicates that a second UE has transmitted a second access request in the subframe using the synchronization code.

In an aspect of the disclosure, a method includes receiving, in a subframe, a first synchronization code from a first UE and a second synchronization code from a second UE, and preventing transmission of an acknowledgment to both the first and second UEs based on a determination that the received first and second synchronization codes are the same.

In an aspect of the disclosure, an apparatus includes means for receiving, in a subframe, a first synchronization code from a first UE and a second synchronization code from a second UE, and means for preventing transmission of an acknowledgment to both the first and second UEs based on a determination that the received first and second synchronization codes are the same.

In an aspect of the disclosure, a computer program product includes a computer-readable medium which includes code for receiving, in a subframe, a first synchronization code from a first UE and a second synchronization code from a second UE, and code for preventing transmission of an acknowledgment to both the first and second UEs based on a determination that the received first and second synchronization codes are the same.

In an aspect of the disclosure, an apparatus includes at least one processor, and a memory coupled to the at least one processor. In such an aspect, the at least one processor may be configured to receive, in a subframe, a first synchronization code from a first UE and a second synchronization code from a second UE, and prevent transmission of an acknowledgment to both the first and second UEs based on a determination that the received first and second synchronization codes are the same.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4A is a functional block diagram conceptually illustrating example blocks executed to implement the functional characteristics of one aspect of the present disclosure.

FIG. 4B is another functional block diagram conceptually illustrating example blocks executed to implement the functional characteristics of one aspect of the present disclosure.

FIG. 5 is yet another functional block diagram conceptually illustrating example blocks executed to implement the functional characteristics of one aspect of the present disclosure.

FIG. 6 is an exemplary UL transmission using an initial time advancement according to an aspect.

FIG. 7 is a block diagram of an exemplary wireless communications device configured to avoid Physical Random Access Channel collisions according to an aspect.

FIG. 8 is a block diagram depicting the architecture of a Node B configured to avoid Physical Random Access Channel collisions according to an aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

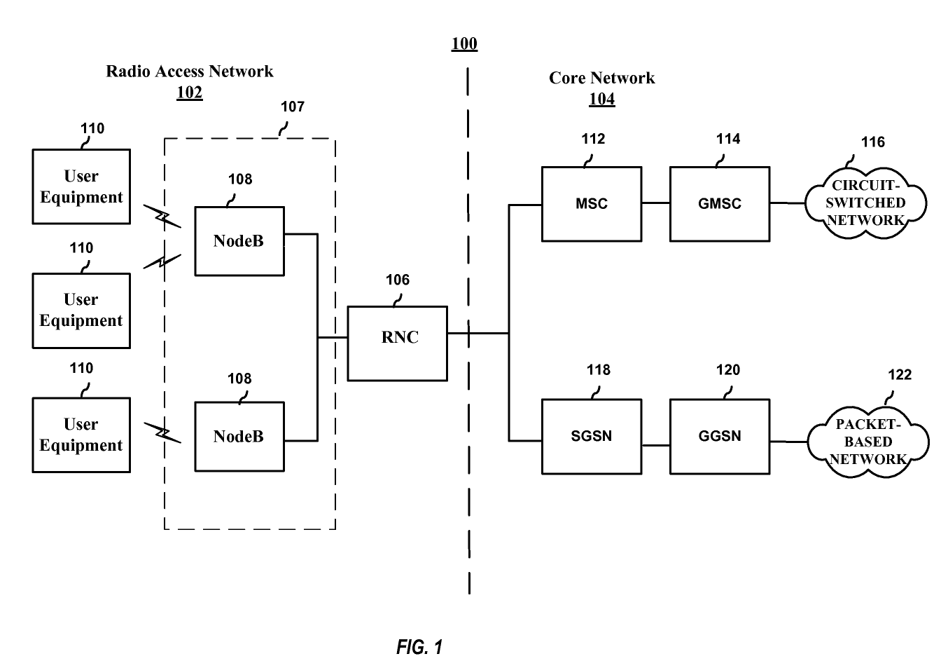

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as UE in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the UL and DL between a Node B 108 and a UE 110, but divides uplink and downlink transmissions into different time slots in the carrier.

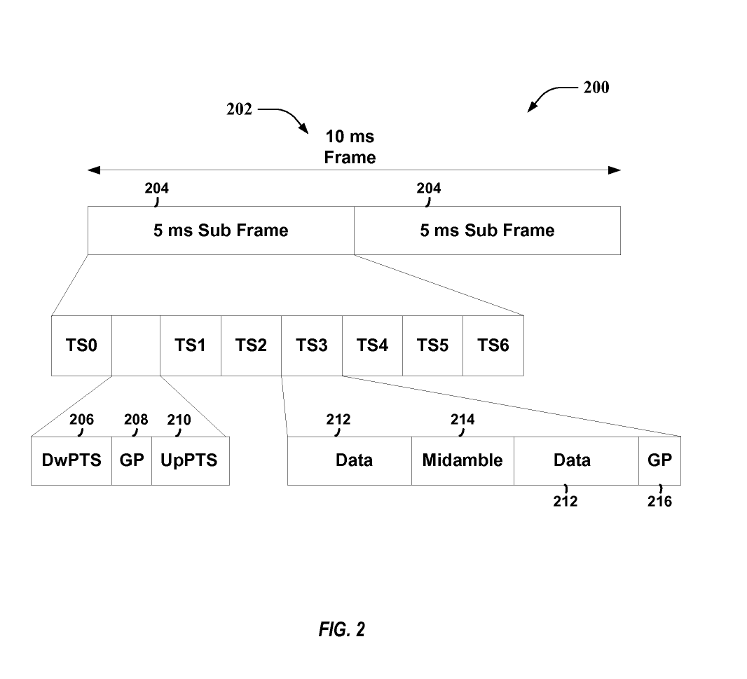

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a GP 216. The midamble 214 may be used for features, such as channel estimation, while the GP 216 may be used to avoid inter-burst interference.

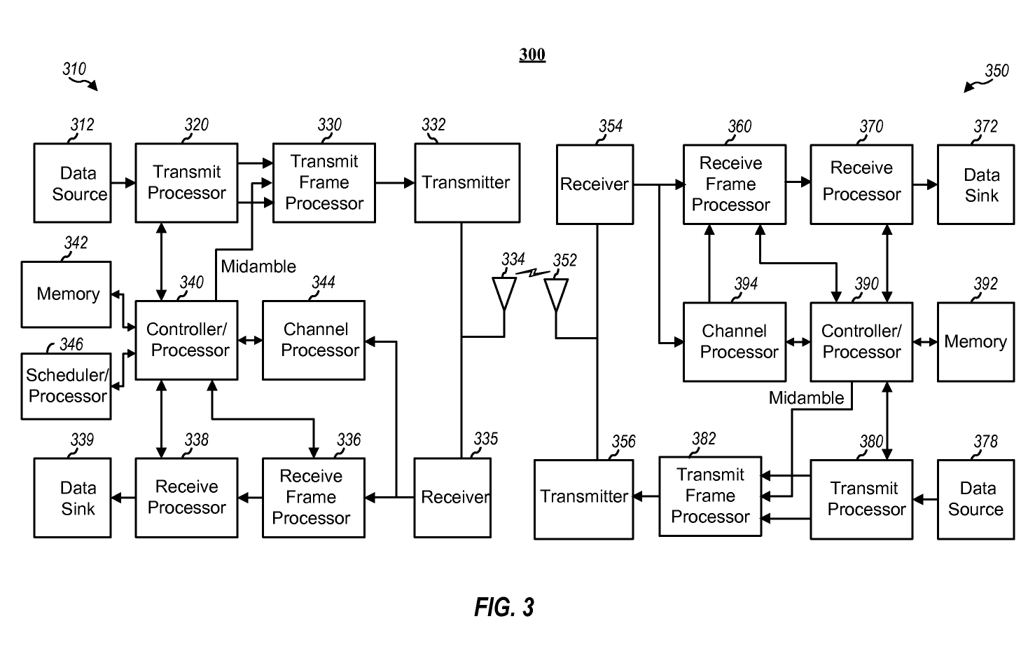

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an ACK and/or NACK protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one aspect, controller/processors 340 and 390 may enable communications using a random access procedure. Generally, in a TD-SCDMA system, using a random access procedure, various channels and configurations may be used. For example, a random access channel (RACH) transmission time interval (TTI) may be denoted by L subframes (e.g. 1 for 5 ms, 2 for 10 ms, 4 for 20 ms), and one FPACH may correspond to N PRACHs, where N≦L. As such, the network may send an ACK on FPACH on a subframe number SFN' mod L=0, 1, . . . , N−1. One example of a general FPACH ACK is discussed with reference to Table 1.

TABLE 1
TD-SCDMA standard FPACH ACK

| Field | Length | Description |
|---|---|---|
| Signature Reference Number | 3 (MSB) | Indicate SYNC_UL |
| | | code |
| Relative Sub-Frame Number | 2 | Sub-Frame number |
| | | preceding the ACK |
| Received starting position of the | 11 | Used for timing |
| UpPCH (UpPCH_{POS}) | | correction |
| Transmit Power Level Command for | 7 | Used for transmit |
| RACH message | | power level in |
| | | PRACH |
| Reserved bits | 9 (LSB) | N/A |

Further, if the UE receives FPACH on subframe number j mod L=n, then it uses PRACH n to transmit to avoid a collision with another UE. Still further, Transmission of RACH may start two subframes following FPACH reception, but if FPACH is received on an odd subframe number and L>1, then three subframes may be needed.

Such random access communications may be set up using various parameters operable to reduce the possibility of multiple UEs attempting to communicate with a Node B 310 using the same random access channel resources. In one aspect, avoiding collisions during random access procedures may be facilitated through various processes performed by at least one of a UE 110, Node B 108, etc.

In one such aspect, if a Node B 310 can detect more than one UE sending the same SYNC_UL code in the same UpPTS, then the Node B 310 may send a modified FPACH ACK message including a concurrent transmission flag. An exemplary FPACH ACK message including a concurrent transmission flag is described in Table 2.

TABLE 2
Modified FPACH ACK

| Field | Length | Description |
|---|---|---|
| Signature Reference Number | 3 (MSB) | Indicate SYNC_UL code |
| Relative Sub-Frame Number | 2 | Sub-Frame number |
| | | preceding the ACK |
| Received starting position of the | 11 | Used for timing |
| UpPCH (UpPCH_{POS}) | | correction |
| Transmit Power Level | 7 | Used for transmit power |
| Command for RACH | | in PRACH |
| message | | |
| Concurrent transmission flag | 1 | Set to 1 if more than one |
| | | UE sending the same |
| | | SYNC_UL code as the |
| | | Signature Reference |
| | | Number |
| Reserved bits | 8 (LSB) | N/A |

In operation in such an aspect, when one or more of the UEs receive the ACK with a concurrent transmission flag set to 1, (e.g. on), the UE may determine that another UE may be attempting to communicating using the same UL resources. After receiving the ACK with the concurrent transmission flag, the UE may respond through various options. One such option may prompt the UE not transmit using the PRACH and the UE may retransmit another randomly selected SYNC_UL code with some random delay. Another option may include the UE generating a random number U within [0,1) and if U<p, then the UE may transmit using the PRACH. Otherwise, the UE may perform retransmission as described above. As such, there may be an increased chance that only one of the UEs may transmit while the other UEs do not transmit, and therefore transmission in PRACH can succeed without collision. However, there is some non-zero probability that collision may occur in PRACH, and in such a case, the system may work as if no modified FRACH ACK has been implemented. By contrast, assuming a UE receives the ACK with a concurrent transmission flag set to 0 (e.g. off), the UE 110 performs normally.

In another such aspect, each UE may verify the parameters in a received ACK, to determine if the ACK is intended for the UE. In other words, the UE may compare delay information derived from the received ACK with delay information derived internally, to determine if the ACK was meant for the UE. In such an aspect, the UE may verify a received starting position of the UpPCH (UpPCH_{POS}) parameter in a received ACK. In one aspect, where T_init+UpPCH_{POS} can synchronize with Node B timing, the equation 1 may be true.

T_init+UpPCH_{POS}=128*8+RTD (1)

Where, RTD is round trip delay and is equal to twice the propagation delay. 128 is used in this example because, the 96-chip GAP and two symbols ahead of DwPCH end in the definition of UpPTS_{TS}. 8 is used in this exemplary equation because the UpPCH_{POS} sent in the FPACH is in units of 1/8 chip. Further, in such an aspect, the UE may arbitrarily use a value T_init in sending the SYNC_UL code. For example, T_init may be chosen as a random value in the range [0, Dmax] where Dmax is the maximum time advancement. Additionally, or in the alternative, T_init=0 may be used.

Secondly, a propagation delay can be estimated based on path loss by the received P-CCPCH, as seen in equation 2.

L(dB)=P-CCPCH Transmission Power−Received P-CCPCH Signal at UE (2)

In one aspect, The P-CCPCH transmission power may be known from a system information message which includes a system information block type 5. Therefore, the UE can use the propagation loss from equation (2) to estimate the propagation delay by a monotonically increasing function, such as seen in equation 3, with an example function shown in equation 4.

D=f(L) (3)

f(x)=a*10^{(b}^{^{*}}^{L+c)} (4)

Where a, b, c are parameters which may be determined using field data, or the like. As can been seen by the equations above more propagation loss results in more propagation delay.

Using the information derived from equations (1)-(4), each UE may determine if the ACK is intended for it or another UE. The UE may assume that the propagation delay derived by the received information may be substantially similar to the propagation delay derived internally if the ACK is intended for the UE. In other words is the RTD determined from equation (1) is substantially similar to two times the propagation delay derived from equations (2)-(4), then the ACK is assumed to be intended for the UE. The level of similarity may be defined through use of a predefined threshold. As such, if |T_init+UpPCH_{POS}−128*8−2*D|>Th, then UE shall not transmit in PRACH.

In yet another such aspect, if the Node B 310 can detect more than one UE sending the same SYNC_UL code in the same UpPTS, then Node B 310 may not send an ACK to the UEs in the FPACH. As such, the UEs sending the same SYNC_UL codes will not transmit in the PRACH. Thereafter, the UEs may perform a retransmission procedure when waiting for ACK has timed out.

In one configuration, the apparatus 350 for wireless communication includes means for transmitting, by a first user equipment (UE), a first access request using a synchronization code in a subframe to a Node B, and means for receiving an acknowledgement from the Node B, wherein the acknowledgement indicates that a second UE has transmitted a second access request in the subframe using the synchronization code. In one aspect, the aforementioned means may be the processor(s) 370, 390 configured to perform the functions recited by the aforementioned means. In another aspect, the aforementioned means may be a module or any apparatus configured to perform the functions recited by the aforementioned means. In another configuration, the apparatus 310 for wireless communications includes means for receiving, in a subframe, a first synchronization code from a first UE and a second synchronization code from a second UE, and means for preventing transmission of an acknowledgment to both the first and second UEs based on a determination that the received first and second synchronization codes are the same. In one aspect, the aforementioned means may be the processor(s) 320, 340 configured to perform the functions recited by the aforementioned means. In another aspect, the aforementioned means may be a module or any apparatus configured to perform the functions recited by the aforementioned means.

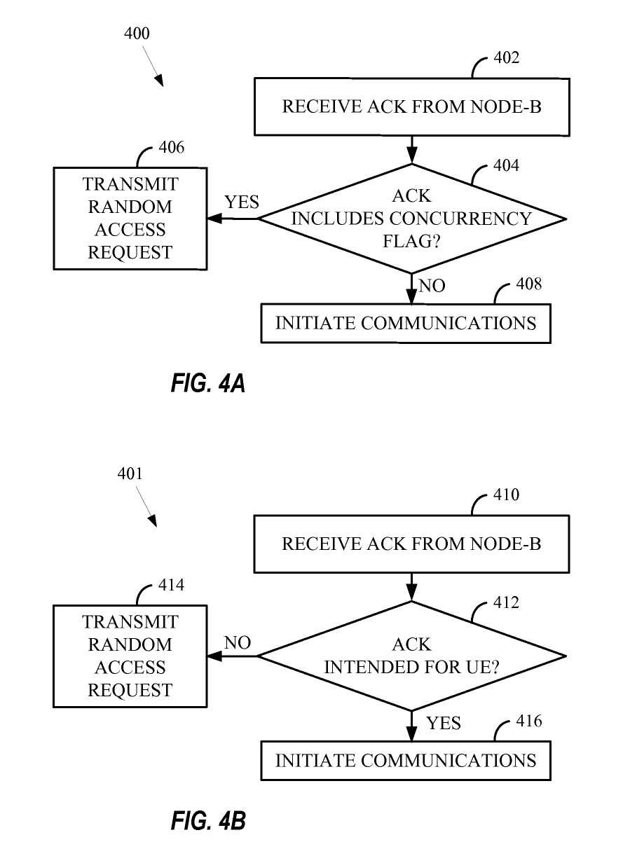

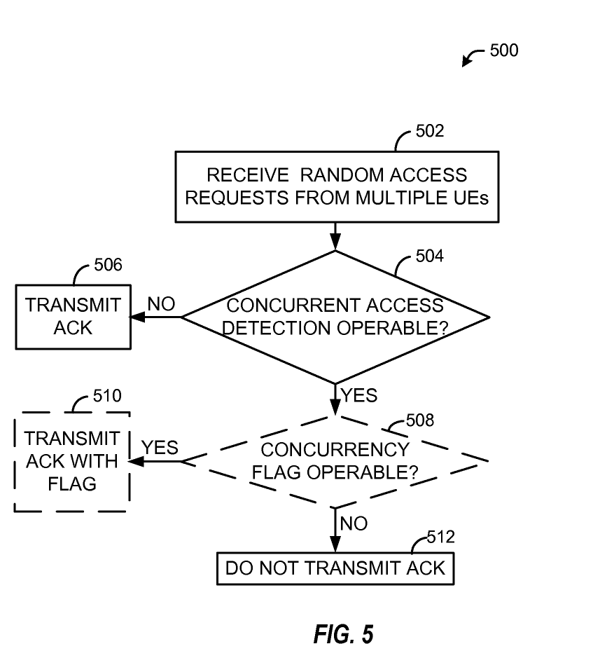

FIGS. 4A, 4B and 5 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4A is a functional block diagram 400 illustrating example blocks executed in conducting wireless communication according to one aspect of the present disclosure. In block 402, a UE may receive an ACK from a Node B. In one aspect, the ACK is received in response to a transmission of a synchronization code (e.g. a SYNC_UL code). In such an aspect, the UE may transmit a synchronization code during initial access procedures. In another such aspect, the UE may transmit a synchronization code during hard handover procedures. Further, in one such aspect, a Node B may bias a response to a UE performing hard handover over a UE performing initial access procedures.

In block 404, it may be determined whether the ACK includes a set concurrent transmission flag. If in block 404, it is determined that the ACK does include a concurrent transmission flag set to 1 (e.g. on), then in block 406, the UE may transmit another random access request. After receiving the ACK with the concurrent transmission flag, the UE may respond through various options. One such option may prompt the UE not transmit using the PRACH and the UE may retransmit another randomly selected SYNC_UL code with some random delay. Another option may include the UE generating a random number U within [0,1) and if U<p, then the UE may transmit using the PRACH. Otherwise, the UE may perform retransmission as described above. As such, there may be an increased chance that only one of the UEs may transmit while the other UEs do not transmit, and therefore transmission in PRACH can succeed without collision. However, there is some non-zero probability that collision may occur in PRACH, and in such a case, the system may work as if no modified FRACH ACK has been implemented.

By contrast, if in block 404, it is determined that no concurrent transmission flag as been set and/or the ACK does not include a concurrent transmission flag, then in block 408, the UE may communicate with the Node B over using the configured path established through the ACK.

FIG. 4B is a functional block diagram 401 illustrating example blocks executed in conducting wireless communication according to one aspect of the present disclosure. In block 410, a UE may receive an ACK from a Node B. In one aspect, the ACK is received in response to a transmission of a synchronization code (e.g. a SYNC_UL code). In such an aspect, the UE may transmit a synchronization code during initial access procedures. In another such aspect, the UE may transmit a synchronization code during hard handover procedures. Further, in one such aspect, a Node B may bias a response to a UE performing hard handover over a UE performing initial access procedures. In block 412, it may be determined whether the ACK was meant for the UE. In one aspect, the UE may compare delay information derived from the received ACK with delay information derived internally, to determine if the ACK was meant for the UE.

If in block 412, it is determined that the ACK was not meant for the UE, then in block 414, the UE may transmit another random access request. By contrast, if in block 412, it is determined that no concurrent transmission flag as been set and/or the ACK does not include a concurrent transmission flag, then in block 416, the UE may communicate with the Node B over using the configured path established through the ACK.

FIG. 5 is a functional block diagram 500 illustrating example blocks executed in conducting wireless communication according to one aspect of the present disclosure. In block 502, Node B may receive random access requests from multiple UEs at approximately the same time. In one aspect, the requests may include a synchronization code (e.g. a SYNC_UL code). In such an aspect, the UE may transmit a synchronization code during initial access procedures. In another such aspect, the UE may transmit a synchronization code during hard handover procedures. Further, in one such aspect, a Node B may bias a response to a UE performing hard handover over a UE performing initial access procedures.

In block 504 it may be determined whether the Node B is operable to detect that multiple UE random access requests have been received. If in block 504 it is determined that the Node B is not operable to detect that multiple UE random access requests have been received, then in block 506, an ACK message may be transmitted. In such an aspect, the multiple UEs may receive the ACK and attempt to respond, resulting in possible collisions. By contrast, if in block 504 it is determined that the Node B is operable to detect that multiple UE random access requests have been received, then in block 508 it may optionally be determined whether the Node B is operable set a concurrent transmission flag in an ACK. If, in such an option aspect, in block 508, it is determined that the Node B is operable set a concurrent transmission flag in an ACK, then in block 510 an ACK with a concurrent transmission flag set to 1 (e.g. on) may transmitted to the multiple UEs. By contrast, if in block 508, it is determined that the Node B is not operable set a concurrent transmission flag in an ACK, then in block 512 an ACK may be prevented from being transmitted. In such an aspect, the UEs may time out in waiting for a response and may retransmit at a later time with another random access request.

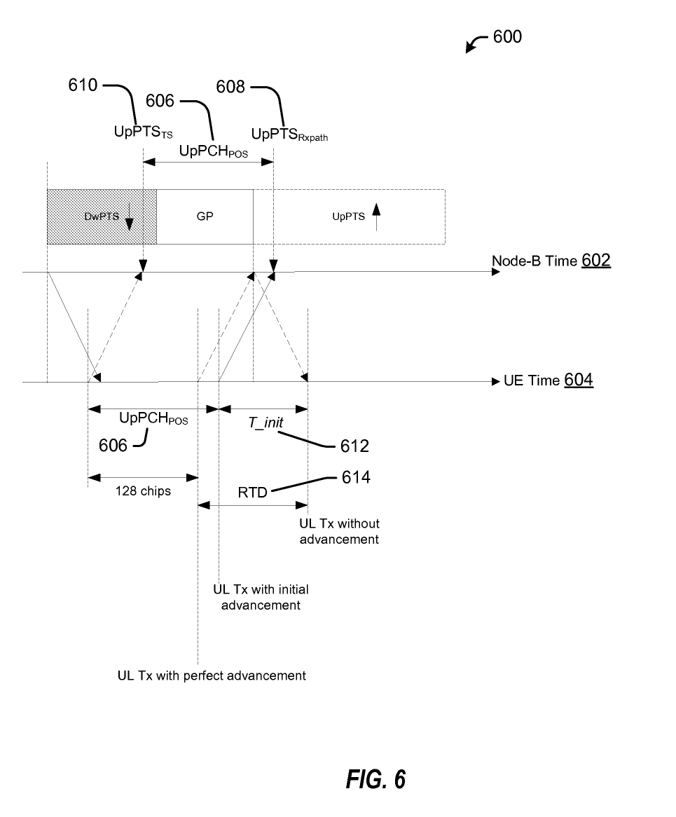

With reference now to FIG. 6, an exemplary UL transmission 600 using an initial time advancement (T_init 612) is illustrated. Depicted in the figure are transmission timing for a Node B 602 and a UE 604. As depicted in FIG. 6, a received starting position of the UpPCH (UpPCH_{POS}) field 606 may indicate to the UE a timing adjustment 612. In one aspect, the Node B may compute a value for this parameter according to equation 5.

UpPCH_{POS}=UpPTS_{Rxpath}−UpPTS_{TS} (5)

Where UpPTS_{Rxpath} 608 is a time of the reception in the Node B of the SYNC-UL to be used in the uplink synchronization process, and UpPTS_{TS} 610 is a time instance two symbols prior to the end of the DwPCH. In one aspect, such a value may be derived according to Node B internal timing. Further, in an aspect, where T_init 612+UpPCH_{POS} 606 can synchronize with Node B time 602, then T_init+UpPCH_{POS}=128*8+RTD, wherein RTD 614 is the round trip delay.

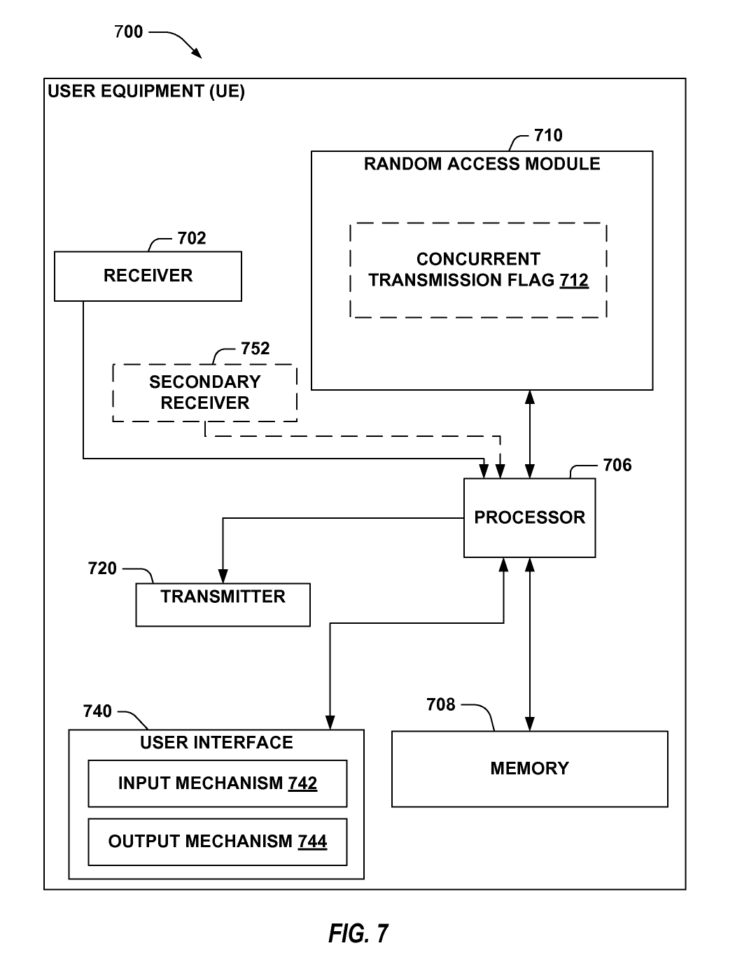

With reference now to FIG. 7, an illustration of a UE 700 (e.g. a client device, wireless communications device (WCD), etc.) that can avoid random access procedure collisions is presented. UE 700 comprises receiver 702 that receives one or more signal from, for instance, one or more receive antennas (not shown), performs typical actions on (e.g., filters, amplifies, downconverts, etc.) the received signal, and digitizes the conditioned signal to obtain samples. Receiver 702 can further comprise an oscillator that can provide a carrier frequency for demodulation of the received signal and a demodulator that can demodulate received symbols and provide them to processor 706 for channel estimation. In one aspect, UE 700 may further comprise secondary receiver 752 and may receive additional channels of information.

Processor 706 can be a processor dedicated to analyzing information received by receiver 702 and/or generating information for transmission by one or more transmitters 720 (for ease of illustration, only one transmitter is shown), a processor that controls one or more components of UE 700, and/or a processor that both analyzes information received by receiver 702 and/or secondary receiver 752, generates information for transmission by transmitter 720 for transmission on one or more transmitting antennas (not shown), and controls one or more components of UE 700.

UE 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 708 of the subject systems and methods is intended to comprise, without being limited to, these and any other suitable types of memory.

UE 700 can further comprise random access module 710 which may be operable to reduce the likelihood of UL collisions during random access procedures for the UE 700. In one aspect, random access module 710 may reduce the likelihood of UL collisions using a variety of processes, such as those described with reference to FIGS. 4A, 4B and 5. In one such aspect, a process may use a concurrent transmission flag 712 to communicate the possibility that multiple UEs may be attempting to use the same UL resources in a manner which may lead to collisions. Moreover, in one aspect of UE 700, processor 706 provides the means for transmitting a first access request using a synchronization code in a subframe to a Node B, and means for receiving an acknowledgement from the Node B, wherein the acknowledgement indicates that a second UE has transmitted a second access request in the subframe using the synchronization code.

Additionally, UE 700 may include user interface 740. User interface 740 may include input mechanism 742 for generating inputs into UE 700, and output mechanism 744 for generating information for consumption by the user of UE 700. For example, input mechanism 742 may include a mechanism such as a key or keyboard, a mouse, a touch-screen display, a microphone, etc. Further, for example, output mechanism 744 may include a display, an audio speaker, a haptic feedback mechanism, a Personal Area Network (PAN) transceiver etc. In the illustrated aspects, output mechanism 744 may include a display operable to present content that is in image or video format or an audio speaker to present content that is in an audio format.

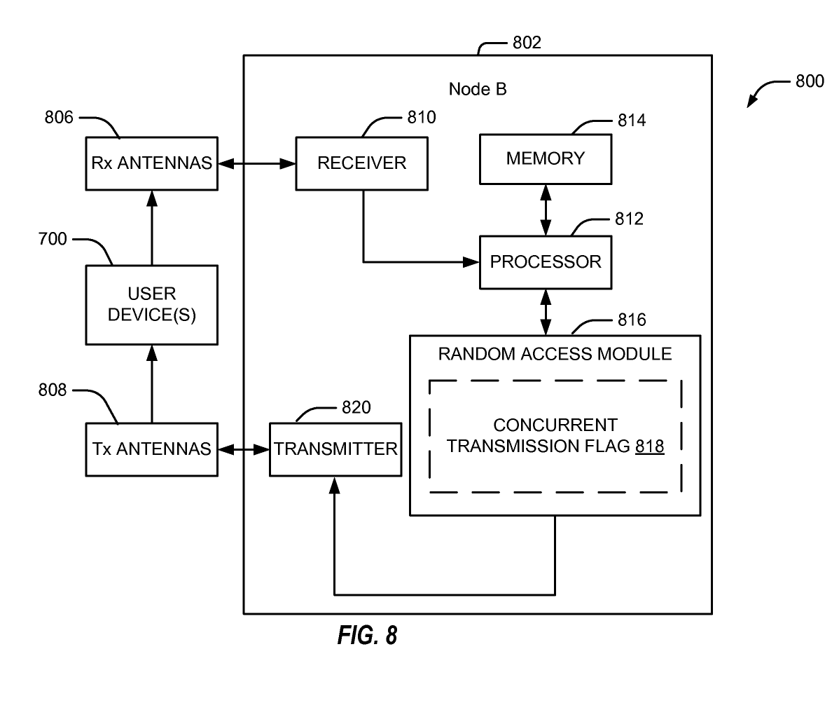

With reference to FIG. 8, an example system 800 that comprises a Node B 802 with a receiver 810 that receives signal(s) from one or more user devices 700 through a plurality of receive antennas 806, and a transmitter 820 that transmits to the one or more user devices 700 through a plurality of transmit antennas 808. Receiver 810 can receive information from receive antennas 806. Symbols may be analyzed by a processor 812 that is similar to the processor described above, and which is coupled to a memory 814 that stores information related to data processing. Processor 812 is further coupled to a random access module 816 that facilitates communications with one or more respective user devices 700 to avoid possible collisions during random access procedures.

In one aspect, random access module 816 may reduce the likelihood of UL collisions using a variety of processes, such as those described with reference to FIGS. 4A, 4B and 5. In one such aspect, a process may use a concurrent transmission flag 818 to communicate the possibility that multiple UEs may be attempting to use the same UL resources in a manner which may lead to collisions. Moreover, in one aspect of Node B 802, processor 812 provides the means for receiving, in a subframe, a first synchronization code from a first user UE and a second synchronization code from a second UE, and means for preventing transmission of an acknowledgment to both the first and second UEs based on a determination that the received first and second synchronization codes are the same.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), RAM, ROM, PROM, EPROM, EEPROM, a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a time division synchronous code division multiple access (TD-SCDMA) system, comprising:
transmitting, by a first user equipment (UE), a first access request using a synchronization code in a subframe to a Node B; and
receiving an acknowledgement from the Node B, wherein the acknowledgement indicates that a second UE has transmitted a second access request in the subframe using the synchronization code.

2. The method of claim 1, wherein the received acknowledgement indicates the second UE has transmitted the second access request by including an active concurrent transmission flag in the acknowledgement.

3. The method of claim 1, wherein the received acknowledgement indicates the second UE has transmitted the second access request by including timing information in the received acknowledgement.

4. The method of claim 3, further comprising:
deriving propagation delay information from the received timing information;
deriving propagation delay information from internal UE measurements;
comparing the prorogation delay information derived from the received timing information with the prorogation delay information derived from the internal UE measurements; and
determining the received acknowledgement is not intended for the first UE when the comparison results in a value greater than a threshold value.

5. The method of claim 1, further comprising:
generating a random number within a defined range; and
communicating with the Node B using configuration information included in the received acknowledgement if the generated random number is less than or equal to a defined value in the defined range; or
generating a second access request using a second synchronization code in a second subframe to a Node B if the generated random number is greater than the defined value in the defined range.

6. The method of claim 5, wherein the first access request, synchronization code, and subframe is different than the second access request, synchronization code, and subframe.

7. The method of claim 1, wherein the first access request is transmitted using an uplink pilot channel (UpPCH), and the acknowledgement is received using a fast physical access channel (FPACH).

8. The method of claim 1, wherein the first access request includes information indicating the first UE is requesting to perform a hand handover, and the acknowledgement includes a bias towards establishing communications with the first UE when the second UE is requesting to perform an initial access procedure.

9. An apparatus for wireless communication in a time division synchronous code division multiple access (TD-SCDMA) system, comprising:
means for transmitting, by a first user equipment (UE), a first access request using a synchronization code in a subframe to a Node B; and
means for an acknowledgement from the Node B, wherein the acknowledgement indicates that a second UE has transmitted a second access request in the subframe using the synchronization code.

10. The apparatus of claim 9, wherein the received acknowledgement indicates the second UE has transmitted the second access request by including an active concurrent transmission flag in the acknowledgement.

11. The apparatus of claim 9, wherein the received acknowledgement indicates the second UE has transmitted the second access request by including timing information in the received acknowledgement.

12. The apparatus of claim 11, further comprising:
means for deriving propagation delay information from the received timing information;
means for deriving propagation delay information from internal UE measurements;
means for comparing the prorogation delay information derived from the received timing information with the prorogation delay information derived from the internal UE measurements; and
means for determining the received acknowledgement is not intended for the first UE when the comparison results in a value greater than a threshold value.

13. The apparatus of claim 9, further comprising:
means for generating a random number within a defined range; and
means for communicating with the Node B using configuration information included in the received acknowledgement if the generated random number is less than or equal to a defined value in the defined range; or
means for generating a second access request using a second synchronization code in a second subframe to a Node B if the generated random number is greater than the defined value in the defined range.

14. The apparatus of claim 13, wherein the first access request, synchronization code, and subframe is different than the second access request, synchronization code, and subframe.

15. The apparatus of claim 9, wherein the first access request is transmitted using an uplink pilot channel (UpPCH), and the acknowledgement is received using a fast physical access channel (FPACH).

16. The apparatus of claim 9, wherein the first access request includes information indicating the first UE is requesting to perform a hand handover, and the acknowledgement includes a bias towards establishing communications with the first UE when the second UE is requesting to perform an initial access procedure.

17. A computer program product, comprising:
a computer-readable medium comprising code for:
transmitting, by a first user equipment (UE), a first access request using a synchronization code in a subframe to a Node B; and
receiving an acknowledgement from the Node B, wherein the acknowledgement indicates that a second UE has transmitted a second access request in the subframe using the synchronization code.

18. The computer program product of claim 17, wherein the received acknowledgement indicates the second UE has transmitted the second access request by including an active concurrent transmission flag in the acknowledgement.

19. The computer program product of claim 17, wherein the received acknowledgement indicates the second UE has transmitted the second access request by including timing information in the received acknowledgement.

20. The computer program product of claim 19, wherein the computer-readable medium further comprises code for:
deriving propagation delay information from the received timing information;
deriving propagation delay information from internal UE measurements;
comparing the prorogation delay information derived from the received timing information with the prorogation delay information derived from the internal UE measurements; and
determining the received acknowledgement is not intended for the first UE when the comparison results in a value greater than a threshold value.

21. The computer program product of claim 17, wherein the computer-readable medium further comprises code for:
generating a random number within a defined range; and
communicating with the Node B using configuration information included in the received acknowledgement if the generated random number is less than or equal to a defined value in the defined range; or
generating a second access request using a second synchronization code in a second subframe to a Node B if the generated random number is greater than the defined value in the defined range.

22. The computer program product of claim 21, wherein the first access request, synchronization code, and subframe is different than the second access request, synchronization code, and subframe.

23. The computer program product of claim 17, wherein the first access request is transmitted using an uplink pilot channel (UpPCH), and the acknowledgement is received using a fast physical access channel (FPACH).

24. The computer program product of claim 17, wherein the first access request includes information indicating the first UE is requesting to perform a hand handover, and the acknowledgement includes a bias towards establishing communications with the first UE when the second UE is requesting to perform an initial access procedure.

25. An apparatus for wireless communication in a time division synchronous code division multiple access (TD-SCDMA) system, comprising:
at least one processor; and
a memory coupled to the at least one processor,
wherein the at least one processor is configured to:
transmit, by a first user equipment (UE), a first access request using a synchronization code in a subframe to a Node B; and
receive an acknowledgement from the Node B, wherein the acknowledgement indicates that a second UE has transmitted a second access request in the subframe using the synchronization code.

26. The apparatus of claim 25, wherein the received acknowledgement indicates the second UE has transmitted the second access request by including an active concurrent transmission flag in the acknowledgement.

27. The apparatus of claim 25, wherein the received acknowledgement indicates the second UE has transmitted the second access request by including timing information in the received acknowledgement.

28. The apparatus of claim 27, wherein the at least one processor is further configured to:
derive propagation delay information from the received timing information;
derive propagation delay information from internal UE measurements;
compare the prorogation delay information derived from the received timing information with the prorogation delay information derived from the internal UE measurements; and
determine the received acknowledgement is not intended for the first UE when the comparison results in a value greater than a threshold value.

29. The apparatus of claim 25, wherein the at least one processor is further configured to:
generate a random number within a defined range; and
communicate with the Node B using configuration information included in the received acknowledgement if the generated random number is less than or equal to a defined value in the defined range; or
generate a second access request using a second synchronization code in a second subframe to a Node B if the generated random number is greater than the defined value in the defined range.

30. The apparatus of claim 29, wherein the first access request, synchronization code, and subframe is different than the second access request, synchronization code, and subframe.

31. The apparatus of claim 25, wherein the first access request is transmitted using an uplink pilot channel (UpPCH), and the acknowledgement is received using a fast physical access channel (FPACH).

32. The apparatus of claim 25, wherein the first access request includes information indicating the first UE is requesting to perform a hand handover, and the acknowledgement includes a bias towards establishing communications with the first UE when the second UE is requesting to perform an initial access procedure.

33. A method of wireless communication in a time division synchronous code division multiple access (TD-SCDMA) system, comprising:
receiving, in a subframe, a first synchronization code from a first user equipment (UE) and a second synchronization code from a second UE; and
preventing transmission of an acknowledgment to both the first and second UEs based on a determination that the received first and second synchronization codes are the same.

34. The method of claim 33, wherein the synchronization codes are used in a random access procedure.

35. The method of claim 33, wherein the first synchronization code from the first user equipment (UE) and the second synchronization code from the second UE are received using an uplink pilot channel (UpPCH).

36. An apparatus for wireless communication in a time division synchronous code division multiple access (TD-SCDMA) system, comprising:
means for receiving, in a subframe, a first synchronization code from a first user equipment (UE) and a second synchronization code from a second UE; and
means for preventing transmission of an acknowledgment to both the first and second UEs based on a determination that the received first and second synchronization codes are the same.

37. The apparatus of claim 36, wherein the synchronization codes are used in a random access procedure.

38. The apparatus of claim 36, wherein the first synchronization code from the first user equipment (UE) and the second synchronization code from the second UE are received using an uplink pilot channel (UpPCH).

39. A computer program product, comprising:
a computer-readable medium comprising code for:
receiving, in a subframe, a first synchronization code from a first user equipment (UE) and a second synchronization code from a second UE; and
preventing transmission of an acknowledgment to both the first and second UEs based on a determination that the received first and second synchronization codes are the same.

40. The computer program product of claim 39, wherein the synchronization codes are used in a random access procedure.

41. The computer program product of claim 39, wherein the first synchronization code from the first user equipment (UE) and the second synchronization code from the second UE are received using an uplink pilot channel (UpPCH).

42. An apparatus for wireless communication in a time division synchronous code division multiple access (TD-SCDMA) system, comprising:
at least one processor; and
a memory coupled to the at least one processor,
wherein the at least one processor is configured to:
receive, in a subframe, a first synchronization code from a first user equipment (UE) and a second synchronization code from a second UE; and
prevent transmission of an acknowledgment to both the first and second UEs based on a determination that the received first and second synchronization codes are the same.

43. The apparatus of claim 42, wherein the synchronization codes are used in a random access procedure.

44. The apparatus of claim 42, wherein the first synchronization code from the first user equipment (UE) and the second synchronization code from the second UE are received using an uplink pilot channel (UpPCH).
